(19) United States
(12) Patent Application Publication
(10) Pub. No.: US 2011/0272998 A1
(43) Pub. Date: Nov. 10, 2011

(54) OMNI-DIRECTIONAL TRANSPORT DEVICE

(76) Inventor: Tsongli Lee, Jhanghua (TW)

(21) Appl. No.: 12/776,433

(22) Filed: May 10, 2010

(51) Int. Cl. B60B 19/12

(52) U.S. Cl. 301/5.23

(57) ABSTRACT

An omni-directional transport device includes a main wheel, a plurality of auxiliary wheels, and a braking mechanism. The main wheel has a main wheel seat, a main wheel axle, and a plurality of auxiliary wheel seats. The main wheel axle connects and rotates the main wheel seat. The plurality of auxiliary wheel seats is arranged to a periphery of the main wheel seat. Each auxiliary wheel has at least one rolling wheel and an auxiliary wheel axle. The auxiliary wheel axle is rotatably arranged to the auxiliary wheel seat, and an angle is between an axis of the auxiliary wheel axle and an axis of the main wheel axle. The braking mechanism is arranged to the main wheel seat to control the rolling of the plurality of auxiliary wheels. By the assembly mentioned above, the omni-directional transport device ensures a safety by preventing an unpredictable and undesired motion.

### FIELD OF THE INVENTION

The present invention relates to wheel, and particular to a safe omni-directional transport device capable of preventing an unpredictable motion.

### DESCRIPTION OF THE PRIOR ART

Prior omni-directional transport devices and U.S. published Pat. No. 6,796,618, No. 6,668,950, and No. 4,223,753 are assemblies of a main wheel having auxiliary wheels rotating freely arranged to a round periphery thereof. An angle θ is between an axis of each auxiliary wheel axle to an axis of the main wheel axle.

The plurality of the auxiliary wheels is freely to roll so that an unpredictable motion by external force is easily happened. Safety issue is a problem of such omni-directional transport device so that other types of wheel are applied with the omni-directional transport device to a carrier or tool such as the U.S. published patents mention above. The other types of wheel will apparently impact the function of the omni-directional transport device.

### SUMMARY OF THE PRESENT INVENTION

The primary object of the present invention is to provide a safe omni-directional transport device capable of preventing an unpredictable motion.

The omni-directional transport device serves as a normal wheel while a braking mechanism locking a plurality of auxiliary wheels. The omni-directional transport device will also move universally while needed by releasing the plurality of the auxiliary wheels. By the braking mechanism of the present invention, an unpredictable and undesirable motion is prevented. A safety concern is ensured while the present invention is applied to various auxiliaries or carriers such as wheelchairs or vehicles without assistance of other types of wheel.

To achieve above object, the present invention provides the plurality of auxiliary wheels having two rolling wheels and a gear wheel individually. The two rolling wheels are fixed to two ends of an auxiliary wheel axle, and the gear wheel is fixed to a center of the auxiliary wheel axle inside an auxiliary wheel seat. The braking mechanism includes a plurality of braking units and first springs, a driving unit, a second spring, an electromagnet, a iron sheet, and two sets of electric brush. The plurality of braking units is able to engage or release gears of the corresponding gear wheel. The plurality of first springs is arranged to corresponding braking units to enforce the braking units leaving the gear wheels. The driving unit will move along an axis direction of the main wheel axle, and a pushing portion of the driving unit is capable of moving the plurality of braking units. The second spring is arranged to the main wheel seat to move the driving unit so that the braking unit will release the gear wheel. The electromagnet is fixed to the main wheel seat, and the iron sheet is fixed to the driving unit. The two sets of electric brush are arranged to the main wheel for providing external power to the electromagnet for attracting the driving unit moving along an axis of the main wheel axle.

### BRIEF DESCRIPTION OF THE DRAWINGS

FIG. 1 is an exploded view of the present invention.

FIG. 2 is an exploded view of the present invention from another angle.

FIG. 3 is a schematic view of the present invention.

FIG. 4 is a top view of the present invention.

FIG. 5 is a cross section view showing a normal state of the present invention.

FIG. 6 is a cross section view showing the present invention capable of move universally.

### DETAILED DESCRIPTION OF THE IVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

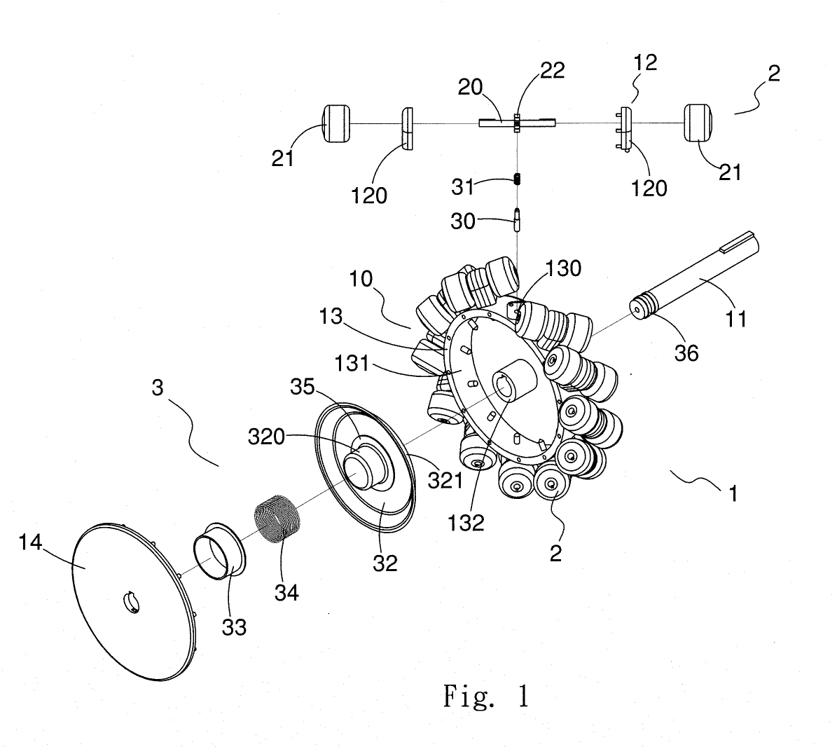

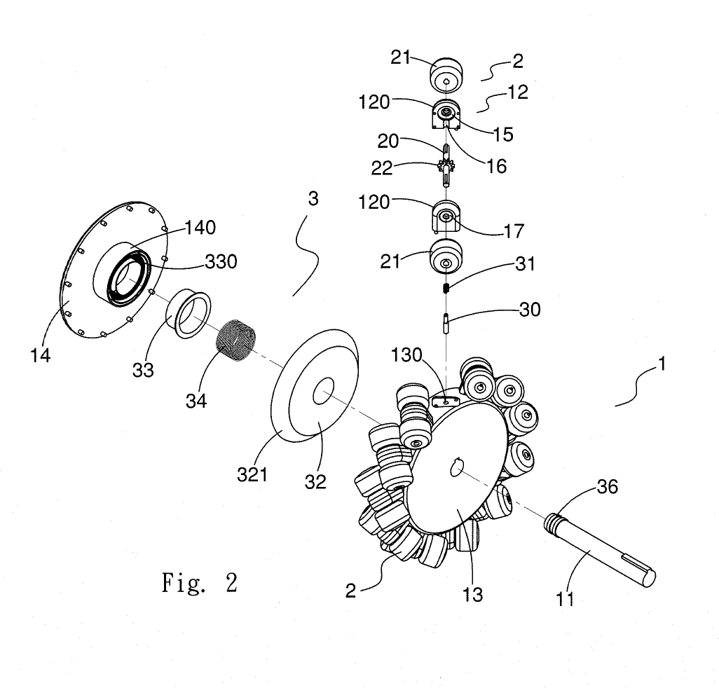

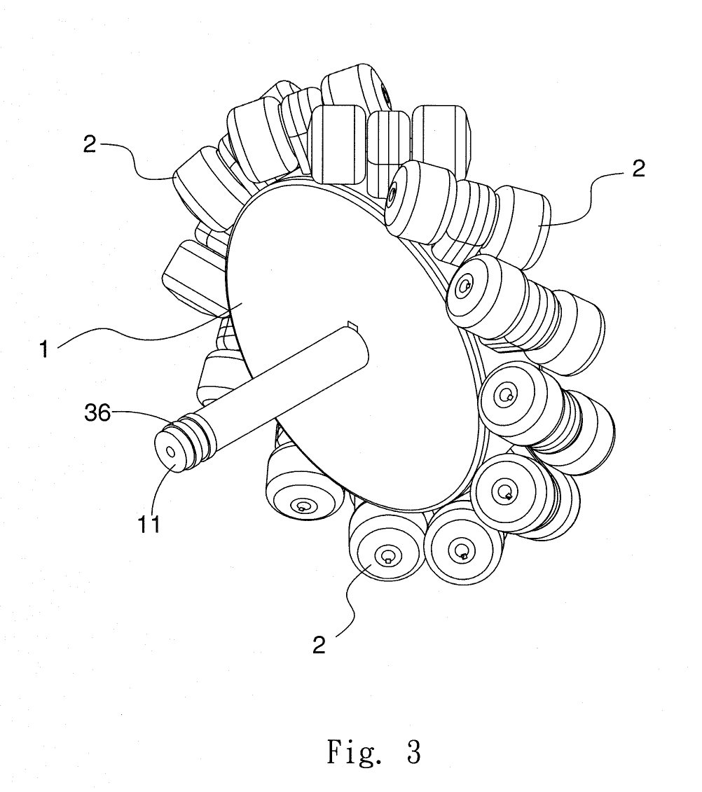

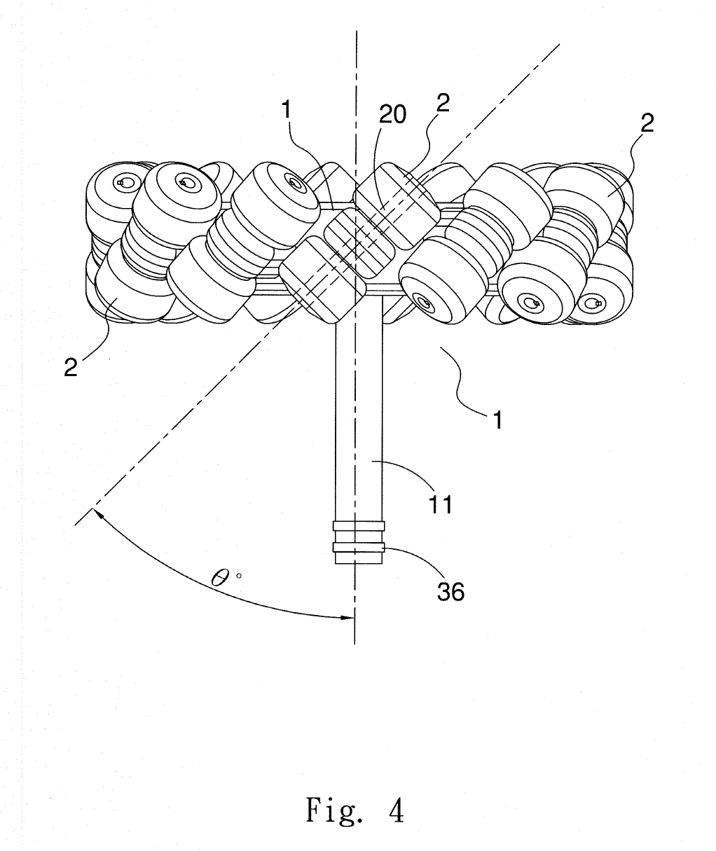

Referring to FIGS. 1 to 5, an omni-directional transport device according to the present invention includes a main wheel 1, a plurality of auxiliary wheels 2, and a brake mechanism 3.

The main wheel 1 has a main wheel seat 10, a main wheel axle 11, and a plurality of auxiliary wheel seats 12. The main wheel seat 10 includes a seat body 13 and a cover body 14. A plurality of sliding holes 130 are formed separately onto a periphery of the seat body 13. A receiving chamber 131 is formed inside the seat body 13, and a sleeve axle 132 is arranged to a center of the receiving chamber 131. The plurality of sliding holes 130 are through holes which communicate the receiving chamber 131. The cover body 14 is arranged to a side of the seat body 13 so as to cover an opening of the receiving chamber 131. A protruding portion 140 formed to a side of the cover body 14 faces to the receiving chamber 131. An end of the main wheel axle 11 fixed into the sleeve axle 132 of the seat body 13 through the protruding portion 140 of the cover body 14 so that the main wheel seat 10 will be rotated through the main wheel axle 11. The auxiliary wheel seats 12 are individually arranged to the sliding holes 130 of the seat body 13. The auxiliary wheel seat 12 is assembled by two case bodies 120 having a receiving slot 15 and a guiding groove 16 on each. The guiding groove 15 serves to communicate the receiving slot 15 and the sliding hole 130. A bearing 17 is arranged to the case body 120.

The auxiliary wheel 2 includes an auxiliary wheel axle 20, two rolling wheels 21 and a gear wheel 22. The auxiliary wheel axle 20 is arranged to the auxiliary wheel seat 12 through the bearings 17 and the receiving slot 15 so that the auxiliary wheel axle 20 is rotatable in the auxiliary wheel seat 12. A predetermined angle θ is between an axis of the auxiliary wheel axle 20 and an axis of the main wheel axle 11. The angle θ is preferable 45 degrees. The two rolling wheels 21 are arranged to two ends of the auxiliary wheel axle 20 on two opposite sides of the auxiliary wheel seat 12. The gear wheel 22 is fixed to a center of the auxiliary wheel axle 20 inside the receiving slot 15 so that the two rolling wheels 22 will roll synchronously.

The brake mechanism 3 is arranged inside the main wheel seat 10 so as to control the rolling of the rolling wheels 21.

Referring to FIGS. 1 to 5, the brake mechanism 3 includes a plurality of braking units 30, a plurality of first springs 31, a driving unit 32, an electro-magnet 33, a second spring 34, an iron sheet 35, and two sets of electric brush 36.

The braking units 30 are individually arranged to each sliding hole 130 of the seat body 13 and outer ends of the braking units 30 are inside the guiding grooves 16 of the auxiliary wheel seats 12 so that the braking units 30 can be slid along the sliding holes 130 and the guiding grooves 16.

The first springs 31 are individually arranged to the braking units 30. Two ends of the first spring push against the braking unit 30 and corresponding auxiliary wheel seat 12 so as to force the braking unit 30 towards the seat body 13.

The driving unit 32 has a cylindrical sleeve 320 for sliding the driving unit 32 along the sleeve axle 132 of the seat body 13. The driving unit 32 can be slid along the axis of the main wheel axle 11 so that an inclined pushing portion 321 formed to a round edge of the driving unit 32 can drive the braking units 30.

The electromagnet 33 is arranged inside the protruding portion 140 of the cover body 14, and coils 330 is arranged around the electromagnet 33.

The second spring 34 is arranged to the cylindrical sleeve 320, two ends of the second spring 34 push against the driving unit 32 and the cover body 14 separately.

The iron sheet 35 is fixed to the driving unit 32 opposite to the electromagnet 33.

The two electric brushes 36 are combined to the main wheel axle 11 so as to conduct external power to the electromagnet 33 to attract the iron sheet 35.

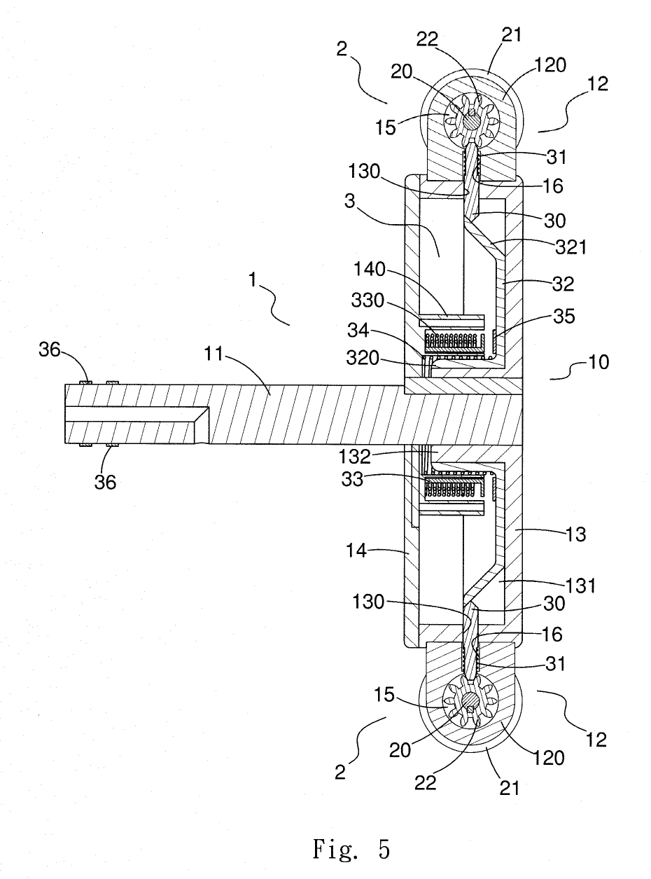

Referring to FIG. 5, a normal state of the omni-directional transport device is illustrated. The electromagnet 33 is not electrified though the electric brushes 36 so that the iron sheet 35 will not be attracted by the electromagnet. The second spring 34 will push the driving unit 32 to a first position. In the mean time, the pushing portion 321 will push the plurality of braking units 30 to a braking position and corresponding first springs 31 is compressed so that the braking units 30 will engage the gear wheels 22 to immobilize the rolling wheels 21. The omni-directional transport device serves as a convention wheel in such status.

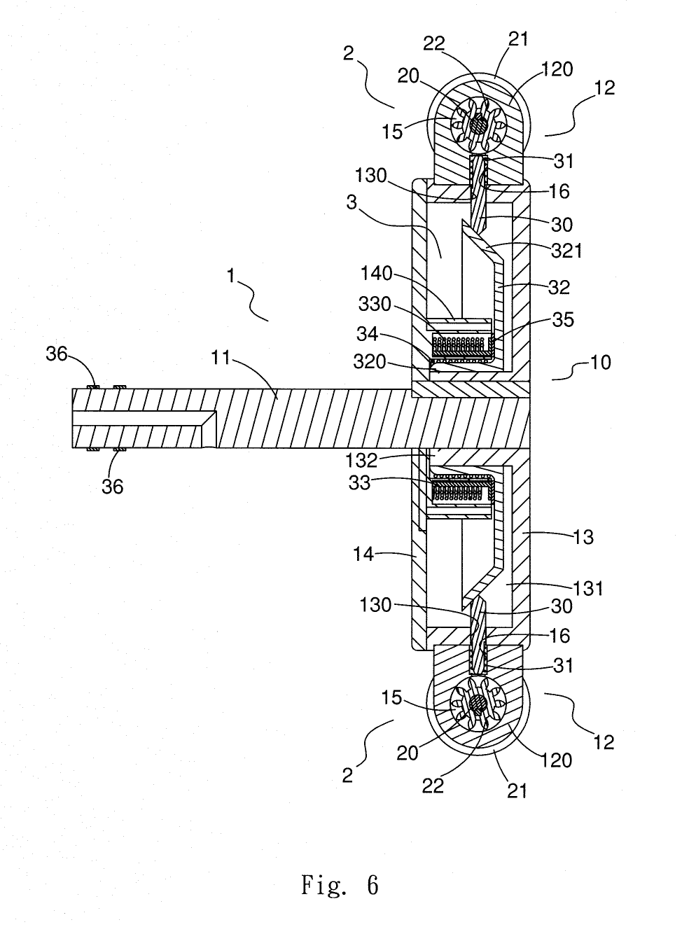

Referring to FIG. 6, the omni-directional transport device capable of travel universally is illustrated. The electromagnet 33 is electrified though the electric brushes 36 so that the iron sheet 35 will be attracted by the electromagnet 33. The iron sheet 35 and the driving unit 32 will thus move to a second position from the first position and the second spring 34 is compressed. In the mean time, the pushing portion 321 will release the plurality of braking units 30 to a release positions by forces from the first springs 31 so that the braking units 30 will free the gear wheels 22 to mobilize the rolling wheels 21. The omni-directional transport device is able to travel universally in such status.

By the braking mechanism of the present invention, the plurality of auxiliary wheels can be locked or released so as to prevent an unpredictable and undesirable motion. A safety concern is ensured while the present invention is applied to various auxiliaries or carriers such as wheelchairs or vehicles without assistance of other types of wheel.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An omni-directional transport device comprising:
a main wheel having a main wheel seat, a main wheel axle, and a plurality of auxiliary wheel seats; the main wheel axle connecting and rotating the main wheel seat; the plurality of auxiliary wheel seats being arranged separately to a round periphery of the main wheel seat;
the plurality of auxiliary wheel seats having at least one rolling wheel and an auxiliary wheel axle individually; the auxiliary wheel axle being rotatalbly arranged to the auxiliary wheel seat; a predetermined angle θ being between axes of the main wheel axle and the auxiliary wheel axle; and
a braking mechanism arranged inside the main wheel seat for controlling the rolling of the plurality of the auxiliary wheels;

2. The omni-directional transport device as claimed in claim 1, wherein each auxiliary wheel has a gear wheel fixed to the auxiliary wheel axle; the gear wheel rotates with the auxiliary wheel synchronously; the braking mechanism includes a plurality of braking units and a driving unit; the plurality of braking units is arranged to the plurality of gear wheels individually; each braking unit will travel along a radial direction to a braking position and a releasing position; the braking unit will engage between gears of the gear wheel while in the braking position, and the braking unit will release the gears of the gear wheel while in the releasing position; the driving unit serves to drive the braking units to both the braking position and the releasing position.

3. The omni-directional transport device as claimed in claim 2, wherein the braking mechanism includes a plurality of first springs arranged to the plurality of the braking units individually; the first springs will provide forces to the braking units from the braking positions towards the releasing positions; the driving unit will move along the axis direction of the main wheel axle to a first position and a second position; the driving unit has a pushing portion; the pushing portion will push the plurality of the braking units to the braking positions and compress the corresponding first springs while the pushing portion is in the first position; the pushing portion will release the plurality of the braking units to the releasing positions from the braking positions while the pushing portion is in the second position.

4. The omni-directional transport device as claimed in claim 3, wherein the braking mechanism includes a second spring, an electromagnet, an iron sheet, and two sets of electric brush; the second spring is arranged to the main wheel seat to push the driving unit from the second position to the first position; the force of the second spring is higher than the force of the plurality of the first springs so that the driving unit will remain in the first position normally; the electromagnet is fixed to the main wheel seat, and the iron sheet is fixed to the driving unit; the two sets of electric brush are arranged to the main wheel axle for conducting external power to the electromagnet so as to attract the iron sheet and the driving unit from the first position to the second position and to compress the second spring.

5. The omni-directional transport device as claimed in claim 4, wherein the main wheel seat has a plurality of sliding holes corresponding to the plurality of the auxiliary wheel for receiving the plurality of the braking units; each auxiliary wheel seat has a receiving slot and a guiding groove linking together for sliding by the corresponding braking unit; each first spring pushes against the braking unit and the auxiliary wheel seat with two ends thereof; each auxiliary wheel axle passes across the corresponding receiving slot, and the gear wheel arranged to the auxiliary wheel axle locates inside the receiving slot; each auxiliary wheel axle has two rolling wheels arranged to two opposite ends of the auxiliary wheel axle.

6. The omni-directional transport device as claimed in claim 5, wherein the pushing portion of the driving unit is an inclined surface.

7. The omni-directional transport device as claimed in claim 6, wherein the main wheel seat includes a seat body and a cover body; the seat body has a receiving chamber for receiving the driving unit, the iron sheet, and the second spring; the receiving chamber has a sleeve axle for sliding receiving the driving unit; the cover body covers the receiving chamber by a side thereof; the cover body has a protruding portion extending into the receiving chamber; the electromagnet is arranged to the protruding portion; two ends of the second spring push against the cover body and the driving unit separately.

8. The omni-directional transport device as claimed in claim 7, wherein the electromagnet is wound by coils.

9. The omni-directional transport device as claimed in claim 8, wherein the plurality of auxiliary wheel seats arranged to a periphery of the main wheel seat is removable.

10. The omni-directional transport device as claimed in claim 9, wherein the auxiliary wheel seat is assembled by two case bodies.

11. The omni-directional transport device as claimed in claim 10, wherein the case body has a bearing for passing by the auxiliary wheel axle.

12. The omni-directional transport device as claimed in claim 7, wherein the angle θ between the axis of the auxiliary wheel axle and the axis of the main wheel axle is preferably 45 degrees.
